(19) United States
(12) Patent Application Publication
(10) Pub. No.: US 2001/0045937 A1
(43) Pub. Date: Nov. 29, 2001

(54) Character input device

(75) Inventors: Yasuji Hagiwara, Fukushima-ken (JP); Masahiro Soma, Fukushima-ken (JP); Youtaro Sakakura, Fukushima-ken (JP); Hiroshi Nakahama, Fukushima-ken (JP)

Correspondence Address: BRINKS HOFER GILSON & LIONE, P.O. BOX 10395, CHICAGO, IL, 60610, US

(73) Assignee: Alps Electric Co., Ltd.

(21) Appl. No.: 09/819,587

(22) Filed: Mar. 28, 2001

(30) Foreign Application Priority Data
May 24, 2000 (JP) 2000-152565

(51) Int. Cl. G09G 5/00

(52) U.S. Cl. 345/156

(57) ABSTRACT

A character input device includes a first manipulator for selecting columns “A”, “KA”, “SA”, . . . in the row direction, a second manipulator for selecting rows “A”, “I”, . . . in the column direction, and a third manipulator for setting a candidate of data of characters or symbols which is selected by the first and second manipulators. The first manipulator, the second manipulator, and the third manipulator are disposed adjacent each other. The first manipulator and the second manipulator are disc-shaped rotary-type input devices. The candidates of characters and the like are quickly transferred in the row and column directions by rotating the first and second manipulators, and are set by operating the third manipulator.

### BACKGROUND OF THE INVENTION

1. Field of the Invention

The present invention relates to character input devices by which character information can be easily inputted.

2. Description of the Related Art

Character input devices are widely used in various electronic apparatuses, such as personal computers, cellular telephones, and game machines.

A keyboard is used as a character input device for a personal computer, the keyboard being provided with a plurality of keytops disposed in positions according to a predetermined specification. In a keyboard of this type, 26 alphabetical letters, kana letters (phonetic symbols in the Japanese syllabary representing fifty phonetic sounds), numerals, symbols, and the like are allocated to the respective keytops. Generally, many keytops are disposed arrayed on a keyboard used for a personal computer. When inputting a kana letter, a keytop to which the kana letter is allocated is selected.

Cellular telephones are used as means of communication with others. Communication is performed by using characters and so on via methods other than voice, such as electronic mail. To communicate using characters and so on, given keys provided on the cellular telephone are manipulated. For example, column “A”, column “KA”, . . . , and column “WA” in the Japanese syllabary are allocated to the keys corresponding to numerals 1, 2, . . . , and 0, respectively. To input the kana letter “KA”, the numeral key “2” is pressed twice, and to input the kana letter “SU”, the numeral key “3” is pressed three times.

In games using a television or a personal computer, particular controllers are used for easier operation. The controller is used for the input of players' names when starting a game, text for a dialogue-type game, files' names in which the game is stored when the game is suspended, and the like. In these cases, the input operation is performed by manipulating a directional key and the like provided on the controller and, for example, by using the Japanese syllabary shown on a display.

FIG. 6 is a perspective view of a controller 40 for a game machine.

The controller 40 is connected to a game machine (not shown) via a cable, and the game machine is connected to a home television which is used as a display for the game machine. The controller 40 includes holding parts 42 and 43 formed at respective ends of a case 41, the holding parts 42 and 43 to be held by the left hand and the right hand, respectively, for manipulation. A directional key unit 44 and an action key unit 45, each including a plurality of keys, are provided on the upper faces of the holding parts 42 and 43, respectively.

When the input of characters is requested, Japanese syllabary 7a is displayed on a television display (a display 7), as shown in FIG. 7. A candidate of selectable character or the like is horizontally and vertically moved to a desired position by manipulating the directional key unit 44 and by using the Japanese syllabary 7a. The candidate is set and is displayed in a predetermined position 7b in the display 7 by pressing the action key unit 45.

However, the problems described below have occurred in the above known character input device.

A character input device such as the above-described keyboard requires a space to be installed, such as on a desk, and cannot be used anywhere. It is difficult for an operator who does not remember the arrangement of the keys to quickly perform the input operation, and experience is necessary for the input operation. Character input by using a cellular telephone requires a number of keypresses, a long time is required for inputting, and it is difficult to perform a quick input operation. Character input by using the above-described game controller requires a long time for moving the selectable candidate to a desired character and it is also difficult to perform a quick input operation.

### SUMMARY OF THE INVENTION

Accordingly, it is an object of the present invention to provide a character input device which can be used at any place to easily and quickly input characters and the like.

To the end, according to an aspect of the present invention, a character input device comprises a display for displaying the whole or part of display candidates of characters and/or symbols which are arrayed in a matrix of M-rows by N-columns; a first manipulator for performing an operation which selects the candidates in the row direction, the first manipulator being either a rotary type or a sliding type; a second manipulator for performing an operation which selects the candidates in the column direction, the second manipulator being either a rotary type or a sliding type; a third manipulator for performing an operation which sets one of the candidates selected by the first manipulator and the second manipulator; and a control unit for controlling the selection of the one candidate according to input operations of the first manipulator and the second manipulator and for setting the one candidate according to an input operation of the third manipulator.

In the character input device according to the present invention, the selection of the candidates displayed on the display is performed by operating the first and second manipulators, and the setting of the selection is performed by operating the third manipulator.

According to another aspect of the present invention, a character input device comprises a display capable of displaying one or a plurality of characters and/or symbols which are arrayed in a matrix of M-rows by N-columns; a first manipulator for displaying the characters and/or symbols by sequentially transferring the characters and/or symbols in the row direction, the first manipulator being either a rotary type or a sliding type; a second manipulator for displaying the characters and/or symbols by sequentially transferring the characters and/or symbols in the column direction, the second manipulator being either a rotary type or a sliding type; a third manipulator for setting display of the characters and/or symbols on the display; and a control unit for controlling the transfer and display of the characters and/or symbols according to input operations of the first manipulator and the second manipulator and for performing setting of the characters and/or symbols according to an input operation of the third manipulator.

One or two characters and/or symbols are displayed while being transferred in the display by operating the first and second manipulators, and the displayed one or two characters and/or symbols are set by operating the third manipulator.

The control unit may control the selection of one from a plurality of the characters and/or symbols according to the input operations of the first manipulator and the second manipulator which are performed when the plurality of characters and/or symbols are displayed on the display, and for setting the selection according to the input operation of the third manipulator.

The control unit may perform control so that a selected row is sequentially displayed in an emphasized manner when operating the first manipulator, and the display of the selected row is emphasized sequentially in the column direction when operating the second manipulator.

The columns may be each composed of five characters and may individually include a character “A” and the characters “KA”, “SA”, “TA”, “NA”, . . . which include consonants, and the individual rows may include the characters respectively consisting of vowels and the characters respectively composed of the consonants and the vowels. The characters may be replaced by English letters, numerals, and/or symbols.

A spherical rotating member may serve as the first manipulator and the second manipulator.

The first manipulator and the second manipulator may be individually provided with loading units so that a clicking sensation is given to the operator every time the row or the column is displayed.

The third manipulator may be disposed in the vicinity of the first manipulator and the second manipulator.

The control unit may be provided with a con version unit in which selection candidates of Chinese characters, which are converted from at least one character set by the input operation of the third manipulator, are displayed on the display.

The display may be included in a terminal device separated from a case in which the first manipulator, the second manipulator, and the third manipulator are included.

In the character input device according to the present invention, the input operation can be performed while holding the device by hands, whereby the character input device can be used anywhere, and characters and symbols can be quickly transferred to and be inputted in a desired position for the characters and symbols by operating the first manipulator by one hand and the second manipulator by the other hand.

The character input device according to the present invention offers advantages as an input device for inputting characters and symbols in particular, in that a space for installing the device is not required, and input operations can be quickly performed. Moreover, an easy input operation is made possible by using the Japanese syllabary displayed when the input operation is performed.

### BRIEF DESCRIPTION OF THE DRAWINGS

FIG. 1 is a schematic perspective view of a character input device according to a first embodiment of the present invention;

FIG. 2 is a functional block diagram of the character input device according to the present invention;

FIG. 3 is a schematic plan view of a character input device according to a second embodiment of the present invention;

FIG. 4 is a perspective view of the internal structure of the character input device according to the present invention;

FIG. 5 is a perspective view of a character input device according to a third embodiment of the present invention;

FIG. 6 is a perspective view of a known character input device; and

FIG. 7 is a schematic view of an image shown in a display when inputting characters.

### DESCRIPTION OF THE PREFERRED EMBODIMENTS

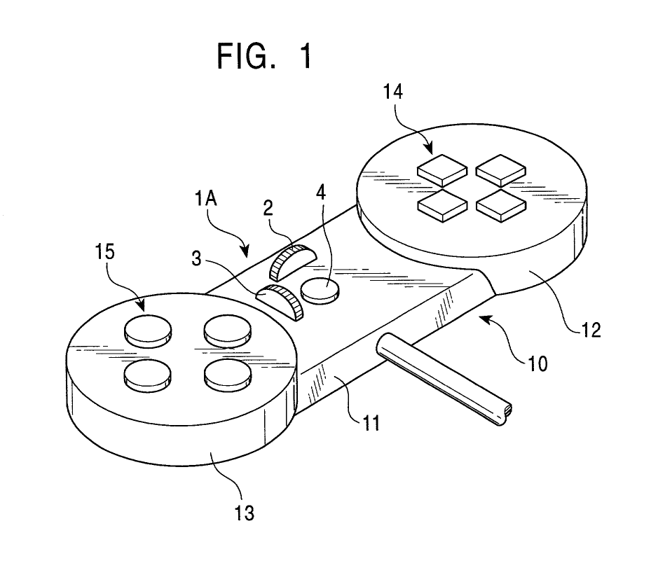

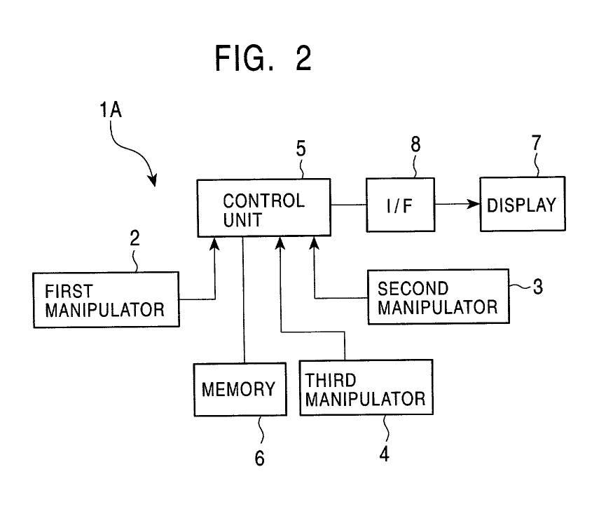

FIGS. 1 and 2 show a first embodiment of a character input device according to the present invention. FIG. 1 is a schematic perspective view of the character input device mounted on a controller for games. FIG. 2 is a functional block diagram of the character input device.

A character input device 1A according to the present invention is used in a game controller (game pad) 10 which includes holding parts 12 and 13 swelling at respective ends of a case 11 so as to be held by hands. The respective holding parts 12 and 13 include a plurality of directional keys 14 and a plurality of action keys 15 on the upper faces, respectively. The directional keys 14 and the action keys 15 are on-off-switching push-type switches. Functions, for example, to shift a cursor in a setup screen and to shift characters appearing in the game may be allocated to the directional keys 14. A function, for example, to put the characters in various motions may be allocated to the action keys 15.

The controller 10, when used for a TV game, is connected to a game machine (not shown) via a given cable, and the game machine is connected to a home television as a display for the game via a given cable. The controller 10, when used for a game for a personal computer, is connected to a game port or the like provided in the computer via a given cable, and a display provided integrally with or separated from the computer is used.

As shown in FIG. 1, the character input device 1A is disposed at a center of the upper face of the case 11. The character input device 1A includes a first manipulator 2, a second manipulator 3, and a third manipulator 4.

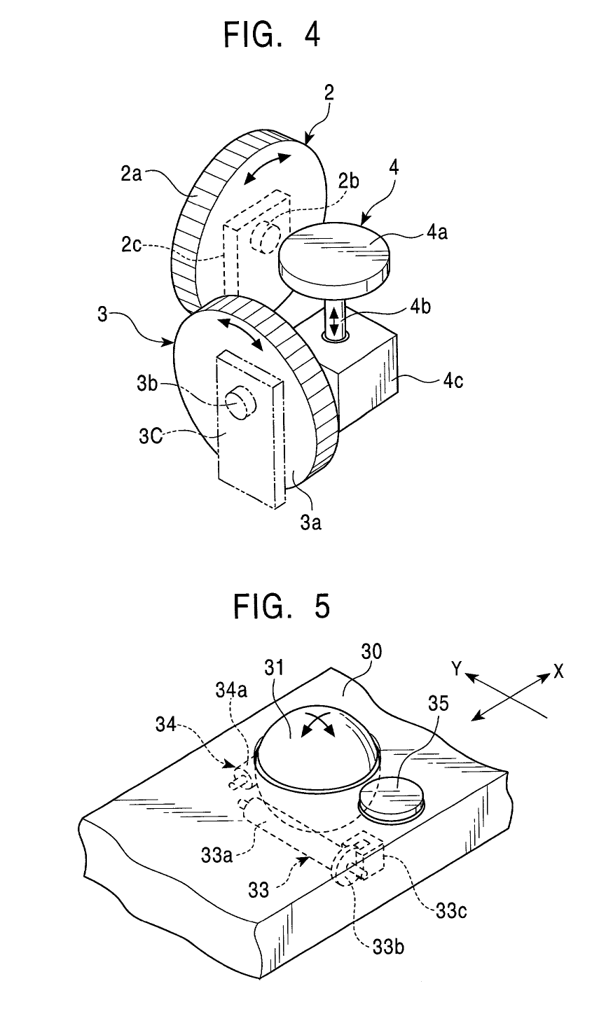

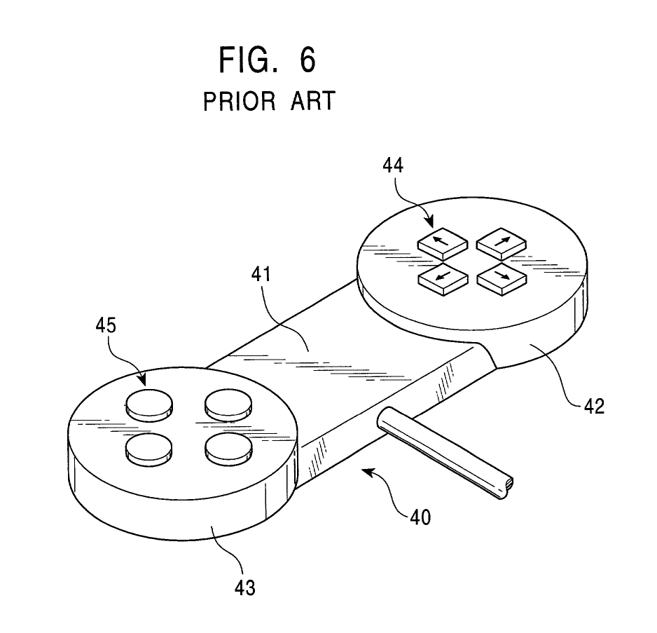

FIG. 4 is a schematic perspective view of the internal structure of the character input device 1A. In FIG. 4, the first and second manipulators 2 and 3 are rotary type inputting units.

The first manipulator 2 includes a disc 2a and a setting unit 2c. The setting unit 2c is fixed to the case 11 at the inside thereof. The disc 2a and a rotational shaft 2b formed integrally with the disc 2a are rotatably supported by the setting unit 2c. An upper part of the disc 2a of the first manipulator 2 slightly protrudes from a cutaway part formed in the upper face of the case 11, whereby the disc 2a can be rotated by a finger.

The second manipulator 3 includes a disc 3a and a setting unit 3c. An upper part of the disc 3a protrudes from the upper face of the case 11, whereby the disc 3a can be rotated by a finger.

The setting units 2c and 3c individually include rotary switches therein. A rotary switch switches the contact between contact points by a minute angle of rotation of the rotary switch. By the rotation of each of the discs 2a and 3a, pulsed outputs are obtained. The setting units 2c and 3c may individually include variable resistors, instead of the rotary switches, with which variable outputs are continuously obtained by the rotation of the discs 2a and 3a.

The rotational shaft 2b is disposed perpendicular to a rotational shaft 3b included in the second manipulator 3. Each rotational shaft 2b or 3b can rotates in both directions.

The third manipulator 4 is disposed in the vicinity of the first manipulator 2 and the second manipulator 3, that is, in the vicinity of the intersection between lines extending along the rotational shaft 2b and along the rotational shaft 3b. The third manipulator 4 is a single-operational push-type (on-off-type) switch.

As shown in FIG. 4, the third manipulator 4 includes a manipulating plate (manipulating button) 4a, a supporting shaft 4b, and a detector 4c disposed in the case 11. The supporting shaft 4b is provided between the detector 4c and the manipulating plate 4a. The manipulating plate 4a is supported so as to be vertically movable. When the manipulating plate 4a of the third manipulator 4 is downwardly pressed, the supporting shaft 4b moves downwardly, whereby a microswitch provided in the detector 4c outputs a switch-on signal, and when the pressing force is released from the manipulating plate 4a, the manipulating plate 4a returns to the original position, whereby a switch-off signal is outputted.

As shown in FIG. 2, the character input device 1A includes the first manipulator 2, the second manipulator 3, the third manipulator 4, a control unit 5, a memory 6, and an interface (I/F) 8. The display 7 is included in, for example, a television to which the game machine is connected.

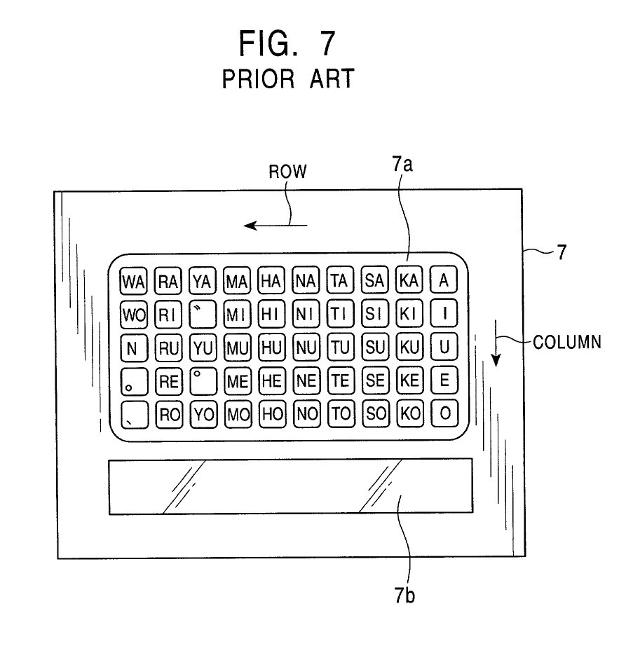

By the character input device 1A, input operations are performed by selecting and displaying a character from display candidates of the characters which are arrayed in M-rows×N-columns, in a manner such as hiragana or katakana letters arrayed in the Japanese syllabary shown in FIG. 7.

In the functional block diagram shown in FIG. 2, the selection of display candidates of the characters and symbols in the row direction is performed by rotating the first manipulator 2, then the selection in the column direction of the display candidates selected in the row direction is performed by rotating the second manipulator 3, and the character or symbol thus selected as a candidate is set by pressing the third manipulator 4, thus, the character or symbol is outputted so as to be displayed in a predetermined position of the display 7. That is, the control unit 5 selects code data particular to the character or symbol through the above-described operations. The memory 6 stores display data (font data) including the characters and symbols which correspond to the code data, and the selected display data are transmitted to the display 7 through the interface 8.

The character input device 1A may be provided with a switching unit for displaying katakana letters, English letters, numerals, and the like other than hiragana letters. A region of the memory 6 may be used for storing the data which have been inputted.

The control unit 5 may be provided with means of conversion for converting kana letters into “kanji” (Chinese character). An operational key for the conversion of kanji may be provided separately, or a key which has been provided may be used as the key for the conversion. By having this function, a character or a plurality of characters selected and displayed by the input operations performed by the first manipulator 2 and the second manipulator 3 are converted to a kanji or a plurality of kanjis. When kana letters are converted to kanjis, display data may be formed in the controller 10 by using a kanji dictionary provided in the memory 6. The display data may be formed by using a dictionary provided in a game machine (not shown).

In the character input device 1A, the Japanese syllabary 7a shown in FIG. 7 is displayed on the display 7 as needed in the game and according to a certain operation. For example, in order to select and input the kana letter “HE”, an emphasized frame or a cursor is transferred to column “HA” by rotating the disc 2a of the first manipulator 2, then the emphasized frame or the cursor is transferred along the column to row “E” by rotating the disc 3a of the second manipulator 3, whereby the letter “HE” as a candidate is displayed in an emphasized manner. When the candidate is displayed in an emphasized manner, the displayed data of the letter “HE” is set by pressing the manipulating plate 4a of the third manipulator 4, and the letter “HE” is outputted so as to be displayed in the predetermined position 7b of the display 7.

In this case, the character input device 1A may be arranged so as to display candidates of kanjis by operating the above-described means when a character or a plurality of characters are displayed in the position 7b, in which the candidates can be selected by rotating the first and second manipulators 2 and 3, and one of the candidates can be set by operating the third manipulator 4.

When all the necessary characters are displayed in the predetermined position 7b, the Japanese syllabary 7a displayed on the display 7 may be erased by, for example, pressing the third manipulator 4 twice.

The character input device 1A may be provided with a loading unit which produces load so that a clicking sensation is given to the discs 2a and 3a from the rotating operation of the first and second manipulators 2 and 3 at every movement thereof by a column and by a row, respectively.

The loading unit may be formed in a manner such that the rotational shafts 2b and 3b of the setting units 2c and 3c, respectively, are individually provided with convexities and concavities at predetermined pitches around the respective rotational shaft 2b and 3b, and a resilient member such as a flat spring is provided so as to engage with the concavities, whereby the clicking sensation is produced when rotating the discs 2a and 3a. The discs 2a and 3a, instead of the rotational shafts 2b and 3b, may be individually provided with the convexities and concavities at predetermined pitches around the respective peripheries of the discs 2a and 3a, whereby the clicking sensation is produced.

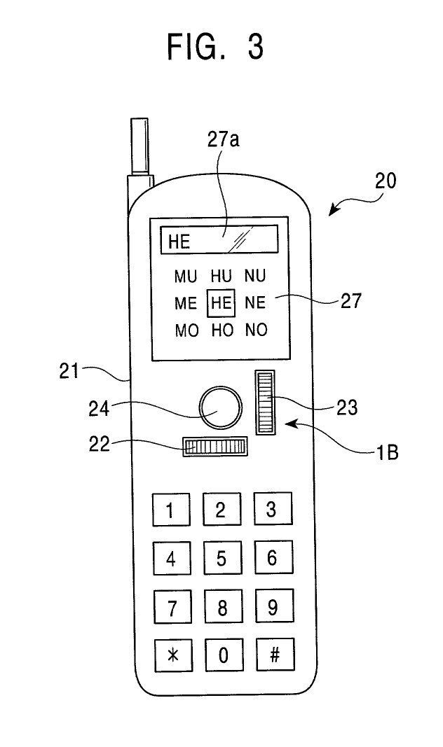

FIG. 3 is a plan view of a cellular telephone which is mounted with a character input device according to a second embodiment of the present invention.

By operating a character input device 1B shown in FIG. 3, data of characters and symbols are inputted and are transmitted, thereby communicating with others who are located separately.

The character input device 1B is provided with a first manipulator 22, a second manipulator 23, and a third manipulator 24. The configuration of the character input device 1B is the same as that of the character input device 1A described above, for which description is omitted.

In FIG. 3, the character input device 1B includes a display 27 formed integrally with a case 21. In such a display as the display 27, the number of characters which can be displayed is limited, and the overall Japanese syllabary 7a shown in FIG. 7 cannot be displayed. In the character input device 1B shown in FIG. 3, only nine characters and/or symbols can be displayed in a matrix of 3 rows by 3 columns. FIG. 3 shows a case in which only characters are displayed on the display 27 of the character input device 1B.

When the nine characters are displayed, as described above, an emphasized frame or a cursor is transferred horizontally along the displayed three rows by operating the first manipulator 22, whereby selection along the row is performed. Then, the emphasized frame or cursor is transferred vertically along the displayed three columns by operating the second manipulator 23, thereby selecting one of the nine characters, and, for example, the character “HE” is set by pressing the third manipulator 24, whereby the character “HE” is displayed in a region 27a of the display 27.

When a desired character is not included in the nine characters, the emphasized frame or cursor is transferred further, for example, to the left from the letter “ME” by rotating the first manipulator 22 to the left, whereby characters included in column “YA”, column “RA”, and column “WA” are sequentially displayed so that each column moves to the right. The characters included in column “TA”, column “SA”, and column “KA” are sequentially displayed by rotating the first manipulator 22 to the right so that each column moves to the left.

When desired three columns of characters are displayed by the above operation, the characters included in the three columns move along the columns (in a vertical direction) and are displayed in the display 27. When the desired character is displayed by being included in the nine characters in the display 27, the desired character is selected by again operating the first and second manipulators 22 and 23, and is set by pressing the third manipulator 24.

In s character input device in which only one character can be displayed on the display 27, each character is sequentially displayed, while moving in the row direction, by operating the first manipulator 22, and is sequentially displayed, while moving in the column direction, by operating the second manipulator 23. When the desired character is displayed, the character is set by operating the third manipulator 24.

The character input device 1B may be provided with means of conversion for converting the characters displayed in the region 27a into kanjis by a predetermined operation.

FIG. 5 is a schematic perspective view of a character input device 30 according to a third embodiment of the present invention. The character input device 30 can be used in an electronic apparatus, such as a game pad, in the same way as the character input device 1A according to the first embodiment.

In FIG. 5, the character input device 30 includes a spherical rotational member 31 and a switch 35 as a third manipulator which is a button-type on-off-switch. Manual rotation of the rotational member 31 drives a first actuator 33 and a second actuator 34 to rotate. The first actuator 33 includes a shaft 33a to be driven for rotation by the rotational member 31 and an encoder 33b (or variable resistor). The second actuator 34 includes a shaft 34a, an encoder, and the like.

By rotating the rotational member 31, thereby driving the actuators 33 and 34, the selection in the row direction and the selection in the column direction can be performed, and the selected character can be set by operating the switch 35 as the third manipulator, in the same way as in the above embodiments.

The character input device according to the present invention is not limited to the first to third embodiments described above, and, for example, the first manipulator and the second manipulator may be selected from sliding switches and sliding variable resistors unless they are push-button-type on-off-switches. The electronic apparatus in which the character input device is used is not limited to the above game pad or cellular telephone, and the character input device may be mounted in an apparatus, which can read data, to be used for, for example, an audio or video device, and for recording titles and the like on recording media. The character input device according to the present invention may be mounted in a remote controller of a car navigation system.

What is claimed is:

1. A character input device comprising:
a display for displaying the whole or part of display candidates of characters and/or symbols which are arrayed in a matrix of M-rows by N-columns;
a first manipulator for performing an operation which selects the candidates in the row direction, the first manipulator being either a rotary type or a sliding type;
a second manipulator for performing an operation which selects the candidates in the column direction, the second manipulator being either a rotary type or a sliding type;
a third manipulator for performing an operation which sets one of the candidates selected by the first manipulator and the second manipulator; and
a control unit for controlling the selection of the one candidate according to input operations of the first manipulator and the second manipulator and for setting the one candidate according to an input operation of the third manipulator.

2. A character input device comprising:
a display capable of displaying one or a plurality of characters and/or symbols which are arrayed in a matrix of M-rows by N-columns;
a first manipulator for displaying the characters and/or symbols by sequentially transferring the characters and/or symbols in the row direction, the first manipulator being either a rotary type or a sliding type;
a second manipulator for displaying the characters and/or symbols by sequentially transferring the characters and/or symbols in the column direction, the second manipulator being either a rotary type or a sliding type;
a third manipulator for setting display of the characters and/or symbols on the display; and
a control unit for controlling the transfer and display of the characters and/or symbols according to input operations of the first manipulator and the second manipulator and for performing setting of the characters and/or symbols according to an input operation of the third manipulator.

3. A character input device according to claim 2, wherein the control unit controls the selection of one from a plurality of the characters and/or symbols according to the input operations of the first manipulator and the second manipulator which are performed when the plurality of characters and/or symbols are displayed on the display, and for setting the selection according to the input operation of the third manipulator.

4. A character input device according to claim 1, wherein the control unit performs control so that a selected row is sequentially displayed in an emphasized manner when operating the first manipulator, and the display of the selected row is emphasized sequentially in the column direction when operating the second manipulator.

5. A character input device according to claim 3, wherein the control unit performs control so that the selected one character or symbol is displayed in an emphasized manner when operating the first manipulator or the second manipulator.

6. A character input device according to claim 1, wherein the columns are each composed of five characters and individually include a character “A” and the characters “KA”, “SA”, “TA”, “NA”, . . . which include consonants, and the individual rows include the characters respectively consisting of vowels and the characters respectively composed of said consonants and said vowels.

7. A character input device according to claim 1, wherein a spherical rotating member serves as the first manipulator and the second manipulator.

8. A character input device according to claim 1, wherein the first manipulator and the second manipulator are individually provided with loading means so that a clicking sensation is given to the operator every time the row or the column is displayed.

9. A character input device according to claim 1, wherein the third manipulator is disposed in the vicinity of the first manipulator and the second manipulator.

10. A character input device according to claim 2, wherein the control unit is provided with conversion means in which selection candidates of Chinese characters, which are converted from at least one character set by the input operation of the third manipulator, are displayed on the display.

11. A character input device according to claim 2, wherein the display is included in a terminal device separated from a case in which the first manipulator, the second manipulator, and the third manipulator are included.
